(19) United States
(12) Patent Application Publication
(10) Pub. No.: US 2021/0268712 A1
(43) Pub. Date: Sep. 2, 2021

(54) MATERIAL STATUS MONITOR SYSTEM, METHOD AND COMPUTER PROGRAM PRODUCT THEREOF

(71) Applicant: Advanced Biomedical Technology Inc., Hsinchu City (TW)

(72) Inventors: Chun-Hung CHEN, Hsinchu City (TW); Ding-Yuan CHEN, Hsinchu City (TW); Chia-Chi HO, Hsinchu City (TW); Sheng-Nan KUO, Hsinchu City (TW)

(21) Appl. No.: 16/826,765

(22) Filed: Mar. 23, 2020

(30) Foreign Application Priority Data
Feb. 27, 2020 (TW) 109106529

(51) Int. Cl. B29C 48/92; B29C 48/50; B29C 64/393

(52) U.S. Cl. CPC B29C 48/92; B29C 48/503; B29C 64/393; B29C 2948/92485; B29C 2948/92152; B29C 2948/92209; B29C 2948/92295

(57) ABSTRACT

A monitor system for monitoring a status of a material in an extruder device is provided. The monitor system includes: a heater, a thermal sensor, a hardness measuring module and a material status monitor. The heater is for heating the material in a material delivering part of the extruder device; the thermal sensor is for measuring a thermal variation of the material; the hardness measuring module is for measuring a first hardness value of the material; and the material status monitor is for determining the status of the material according to the thermal variation and the first hardness value.

### BACKGROUND OF THE INVENTION

### 1. Field of the Invention

The present invention relates to monitor technique and, more particularly, to monitor technique for material status.

### 2. Description of Related Art

The existing technology of additive manufacturing, including three-dimensional (3D) or 4D-nD spatial printing, etc., becomes increasingly popular, and even can be used in the medical field. Users can input specific printing parameters of selected printing condiction, printing material and 3D image into the additive manufacturing machine for printing task. However, there are still many problems in the control of the printing material. For example, illegal material, deteriorating material or error material may cause the failure in the printing task. If the printing product is applied to the medical field, it may cause medical disputes.

Therefore, it is desirable to provide a monitor system, method and computer program product to solve the aforementioned problem.

### SUMMARY OF THE INVENTION

One object of the present invention is to provide a monitor system for monitoring a status of a material in an extruder device. The monitor system comprises a heater, a thermal sensor, a hardness measuring module and a material status monitor. The heater is for heating the material in a material delivering part of the extruder device; the thermal sensor is for measuring a thermal variation of the material; the hardness measuring module is for measuring a first hardness value of the material; the material status monitor is for determining the status of the material according to the thermal variation and the first hardness value.

Another object of the present invention is to provide a monitor method executed by a monitor system for monitoring a status of a material in an extruder device. The method comprises the steps of: heating the material in a material delivering part of the extruder device; measuring a thermal variation of the material; measuring a first hardness value of the material; and determining the status of the material according to the thermal variation and the first hardness value.

Yet another object of the present invention is to provide a computer program product stored in a non-transitory computer-readable medium for an operation of a monitor system, wherein the monitor system is used to monitor a status of a material in an extruder device, wherein the computer program product comprises: an instruction, enabling the monitor system to heat the material in a material delivering part; an instruction, enabling the monitor system to measure a thermal variation of the material; an instruction, enabling the monitor system to measure a first hardness value of the material; and an instruction enabling the monitor system to determine the status of the material according to the thermal variation and the first hardness value.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a structure of a monitor system according to an embodiment of the invention;

FIG. 2(A) is a stereogram diagram of a detailed structure of the material delivering part according to an embodiment of the invention;

FIG. 2(B) is a schematic diagram of a detail structure of the material delivering part according to an embodiment of the invention;

FIG. 3 is a schematic diagram illustrating a detailed structure of the material status monitor according to an embodiment of the invention;

FIG. 4 is a flow chart of the monitoring method according to an embodiment of the invention;

FIG. 5 is a detailed flow chart of the step S43 according to an embodiment of the invention;

FIG. 6(A) is a detailed flow chart of step S44 according to an embodiment of the invention;

FIG. 6(B) is a detailed flow chart of step S44 according to another embodiment of the invention;

FIG. 7(A) is a detailed flow chart of step S45 according to an embodiment of the invention;

FIG. 7(B) is a detailed flow chart of step S45 according to another embodiment of the invention.

### DETAILED DESCRIPTION OF THE PREFERRED EMBODIMENT

In the following description, various embodiments will be provided to explain the implementation and operation of the present invention. The person skilled in the art of the present invention will understand the features and advantages of the present invention through these embodiments. Various combinations, modifications, substitutions or adaptations may be realized based on the present invention.

Furthermore, the use of the ordinal numbers such as “first”, “second”, etc. in the specification and claims to modify the elements of the claims do not imply that a claimed element is physically provided with an ordinal number. The ordinal numbers do not represent the order between a claimed element and another claimed element, or the order of a manufacturing method. The use of these ordinal numbers is only for clearly distinguishing a claimed element having a certain name from another claimed element having the same name.

It is to be noted that, any description hereinafter using “when . . . ” or “at the time of . . . ” is intended to comprise a time “concurrent to, before, or after” the time indicated by either of the two phrases happens. Besides, when there are more than one effects recited in association with one element, component or assembly, as long as these effects are conjoined by the term “or”, any of these effects may be exist independently and the possibility of coexistence of plural such effects is not excluded. Moreover, in the specification and the appended claims, the recitation of “a particular operation executed by a unit” means the unit can not only execute the particular operation, but also execute other operations.

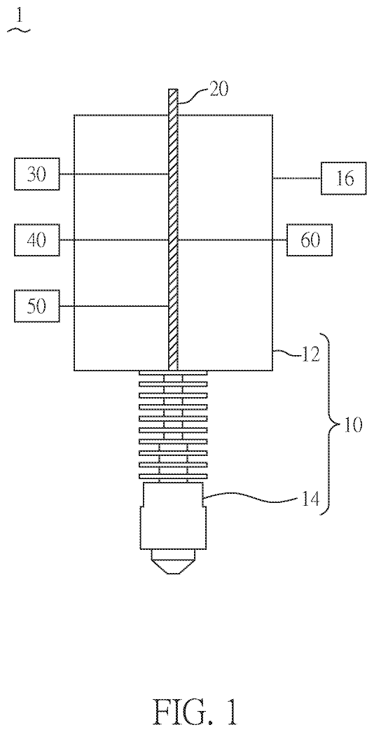

FIG. 1 is a schematic diagram of a structure of a monitor system 1 according to an embodiment of the invention. The monitor system 1 is for monitoring a status of a material 20 in an extruder device 10. As shown in FIG. 1, the monitor system 1 comprises a heater 30, a thermal sensor 40, a hardness measuring module 50 and a material status monitor 60. In an embodiment, the monitor system 1 can comprise the extruder device 10. The extruder device 10 can comprise a material delivering part 12 and a nozzle part 14, wherein the material 20 can be placed in the material delivering part 12. Besides, the heater 30 can heat the material 20 in the material delivering part 12 of the extruder device 10. The thermal sensor 40 can measure a thermal variation of the material 20. The hardness measuring module 50 can measure a first hardness value of the material 20. The material status monitor 60 can determine the status of the material 20 according to the thermal variation and the first hardness value, e.g. the material status monitor 60 can determine the status of the material 20 is a normal status or an abnormal status. The material delivering part 12 is connected to the nozzle part 14 for delivering the material 20 to the nozzle part 14, and the nozzle part 14 heats the material 20 to a specific temperature and ejects out the material 20 when a printing mission is executed.

In an embodiment, the material status monitor 60 can transmit different instructions to the extruder device 10 for controlling an execution of the extruder device 10. In an embodiment, when the material status monitor 60 determines the material 20 is in the normal status, the material status monitor 60 transmits a first control instruction to the extruder device 10 for controlling the extruder device 10 to eject out the material 20. In an embodiment, when the material status monitor 60 determines the material 20 is in the abnormal status, the material status monitor 60 transmits a second control instruction to the extruder device 10 for disabling the execution of the extruder device 10, e.g. to stop the execution of the extruder device 10. Thus, the monitor system 1 of the invention can prevent an abnormal material from being used in the extruder device 10.

The detail of said components will be described in the following paragraphs.

The detail of the extruder device 10 will be described herein. In an embodiment, the extruder device 10 is suitable for a two-dimensional plane printing device, a three-dimensional space additive manufacturing device or a n-dimensional space additive manufacturing device, wherein n is a positive integer greater than 3; in other words, the extruder device 10 can be an extruder of two-dimensional plane printing machine or multidimensional space additive manufacturing machine, such as a 3D printer, an nD printer (where n is greater than 4), a robot arm, etc., but it is not limited thereto. For the sake of clarity, the following paragraphs will be given by taking the 3D printer as an example.

Besides, the extruder device 10 can comprise a microcontroller 16 for controlling executions of the inner components of the extruder device 10. In an embodiment, the microcontroller 16 receives an instruction from the material status monitor 60, and controls the execution of the material delivering part 12 or the nozzle part 14, but it is not limited thereto. In an embodiment, the microcontroller 16 can be integrated with the material status monitor 60.

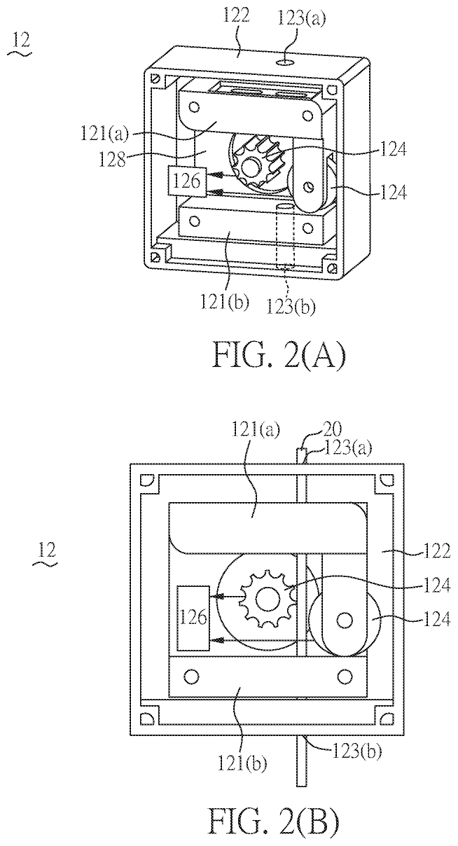

The detail of the material delivering part 12 will be described herein. FIG. 2(A) is a stereogram diagram of a detailed structure of the material delivering part according to an embodiment of the invention. FIG. 2(B) is a schematic diagram of a detailed structure of the material delivering part 12 according to an embodiment of the invention, and please refer to FIG. 1 and FIGS. 2(A)-2(B). As shown in FIGS. 2(A)-2(B), the material delivering part 12 comprises a first supporting component 121(a), a second supporting component 121(b), a cover 122, a plurality of rollers 124, a rotating motor 126 and a containing space 128. The cover 122 can surround the containing space 128. The cover 122 can comprise a feeding opening 123(a) and a exiting opening 123(b), and the material 20 can enter the containing space 128 through the feeding opening 123(a) and enter the nozzle part 14 through the exiting opening 123(b). The first supporting component 121(a) is disposed in the containing space 128 and is adjacent to the feeding opening 123(a). The second supporting component 121(b) is disposed in the containing space 128 and is adjacent to the exiting opening 123(b). The first supporting component 121(a) and the second supporting component 121(b) have at least a hole for containing and retaining the material 20, respectively. The rollers 124 are disposed in the containing space 128 and are disposed surrounding the material 20, for example, one of the rollers 124 can be located on the left side of the material 20 and in contact with the material, and the other one can be located on the right side of the material 20 and in contact with the material. In an embodiment, the rollers 124 can have different sizes or different shape. Besides, the rotating motor 126 can drive the rollers 124 to rotate for delivering the material 20, so that the material 20 can be moved in the containing space 128. In an embodiment, a moving direction of the material 20 can be changed by changing a rotating direction of the rollers 124.

In an embodiment, the material delivering part 12 can be any shape, e.g. a rectangle shape or a tubular shape, and is not limited thereto. In an embodiment, the cover 122 can be composed by any material, e.g. a metal, a ceramic, and is not limited thereto. In an embodiment, a distance between the feeding opening 123(a) and the exiting opening 123(b) is regarded as a delivering path of the material, and the delivering path has a length. In an embodiment, the outer diameter of the feeding opening 123(a) or the exiting opening 123(b) is in a range from 1 mm to 3 mm (i.e. 1 mm≤L1≤3 mm). In an embodiment, the outer diameter of the feeding opening 123(a) or the exiting opening 123(b) is in a range from 1.75 mm to 2.85 mm (i.e. 1.75 mm≤L1≤2.85 mm).

The detail of the heater 30 will be described herein. In an embodiment, the heater 30 can be disposed surrounding the cover 122 or can be embedded in the cover 122, and the heater 30 heats the cover 122 according to an instruction from the microcontroller 16, so that the material 20 can be heated. In an embodiment, the heater 30 can be disposed in the containing space 128, e.g. can be disposed on the first supporting component 121(a). In an embodiment, the heater 30 can be implemented by any heater, a beating tube, a temperature-rising electronic device, a PTC thermistor heating device, a temperature-rising and heat-resisting ceramic device, a temperature-rising and heat-resisting non-metal device, a far-infrared heating device, or a semiconductor device, and is not limited thereto.

The detail of the thermal sensor 40 will be described herein. In an embodiment, the thermal sensor 40 can be used to sense a temperature of the material 20, wherein the term “a temperature of the material 20” can be a temperature of a specific position of the material 20 or an average temperature of the material 20, and is not limited thereto. In an embodiment, the thermal sensor 40 can be configured to measure an original temperature of the material 20 before the material 20 is heated. The original temperature, measured before the heating, of the material 20 is compared with the temperature, measured after the heating, of the material 20, so as to acquire the thermal variation. In an embodiment, the thermal sensor 40 can be implemented by thermocouple technique, resistance temperature detector (RTD) technique or thermistor technique, and is not limited thereto. In an embodiment, a plurality of thermal sensors 40 can be disponed in the material delivering part 12, e.g. one of the thermal sensors 40 can be disposed on the feeding opening 123(a), be disposed adjacent the feeding opening 123(a) or be disposed on the first supporting component 121(a), for measuring the original temperature of the material 20 before the material 20 is heated. Another thermal sensor 40 can be disposed away from the feeding opening 123(a), and it can be for example disposed on the second supporting component 121(b), for measuring the temperature of the material 20 after the material 20 is heated by the heater 30. In another embodiment, only one thermal sensor 40 is disposed in the material delivering part 12, and the thermal sensor 40 measures the temperatures of the material 20 at different times. However, the invention is not limited thereto. In an embodiment, the thermal variation can be transformed to the enthalpy, and is not limited thereto.

The detail of hardness measuring module 50 is described herein. In an embodiment, the hardness measuring module 50 can measure a hardness value of the material 20, wherein the hardness value can be an elasticity value, a pressure value, a tension value, a softness value, an elasticity variation, a pressure variation, a tension variation or a softness variation, and is not limited thereto. In an embodiment, the hardness measuring module 50 can be implemented by a pressure sensor for measuring the pressure value or the pressure variation of the material 20. In an embodiment, the hardness measuring module 50 can be implemented by a tension sensor for measuring the tension value or the tension variation of the material 20. In an embodiment, the hardness measuring module 50 can be a wire diameter measuring unit for measure the wire diameter of the material 20. In an embodiment, the hardness measuring module 50 can be connected with the rotating motor 126, so that the hardness measuring module 50 can acquire the hardness value of the material 20 according to a rotating torque or a rotating speed. Further, the rotating motor 126 can have a voltage generator, and the rotating torque or the rotating speed can be presented by a voltage level generated from the rotating motor 126, and is not limited thereto. In another embodiment, the rotating motor 126 can have a spring, and the rotating torque or the rotating speed can be presented by a transformation of the spring, and is not lilted thereto. Besides, the hardness measuring module 50 can comprise a calculator for converting the data format of the measured original data to different data formats, but is not limited thereto.

Besides, in an embodiment, when the hardness module 50 is the pressure sensor, the tension sensor or the wire diameter, the hardness module 50 can be disposed on the feeding opening 123(a), the exiting opening 123(b), the first supporting component 121(a) or the second supporting component 121(b), and is not limited thereto. The advantage of “the hardness module 50 disposed on the first supporting component 121(a) or the second supporting component 121(b)” is that the hardness module 50 can be used on the extruder device in common use, and the extruder device doesn't need to install a sensor with a particular specification (e.g. a pressure sensor with the particular specification). The advantage of “the hardness module 50 disposed on the feeding opening 123(a), the exiting opening 123(b)” is that the hardness module 50 can be a detachable tubular object, but the extruder device needs to install a sensor with a particular specification (e.g. a pressure sensor with the particular specification).

The detail of the microcontroller 16 is described herein. In an embodiment, the microcontroller 16 is a controller in the extruder device 10, but is not limited thereto. In an embodiment, the microcontroller 16 can comprise a first microprocessor 161 having a capability to process data, e.g. to analyze data. In an embodiment, the first microprocessor 161 can execute a first computer program product 162 comprising a plurality of instructions for enabling the microcontroller 16 to implement some special functions, e.g. to control the components of the extruder device 10.

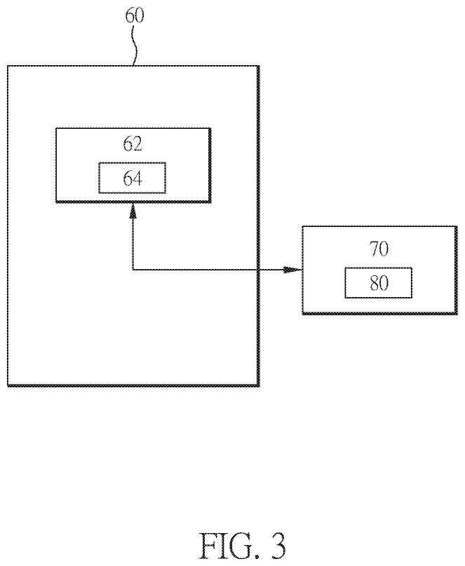

The detail of the material status monitor 60 is described herein. FIG. 3 is a schematic diagram illustrating a detailed structure of the material status monitor 60 according to an embodiment of the invention, and please refer to FIGS. 1 to 3. In an embodiment, the material status monitor 60 can comprise a second microprocessor 62 having a capability to process data. In an embodiment, the second microprocessor 62 can execute a second computer program product 64 comprising a plurality of instructions for enabling the material status monitor 60 to implement some particular functions, e.g. to determine the status of the material 20 or to control the execution of the extruder device 10.

In an embodiment, the material status monitor 60 is disposed outside the extruder device 10, for example, the material status monitor 60 is disposed on a computer device or a server, and the extruder device 10 or the 3D printing machine can have a wire/wireless communication apparatus for transmitting or receiving data with the computer device or the server. In another embodiment, the microcontroller 16 and the material status monitor 60 can be integrated, so that the material status monitor 60 can be disposed in the extruder device 10, and is not limited thereto.

Besides, in an embodiment, the first computer program product 162 and the second computer program product 64 can be integrated, i.e. the first computer program product 162 and the second computer program product 64 can be two sub programs of a main program, and are not limited thereto.

In an embodiment, the material status monitor 60 can be connected to a memory 70 for receiving data stored in the memory 70. The memory 70 can be a storage device, e.g. a hardware, a universal serial bus (USB) device, etc. Alternatively, the memory 70 can be implemented by an electronic circuit. In an embodiment, the memory 70 can store a plurality of label codes 80, wherein each label code 80 corresponds to a thermal variation range and at least a hardness value range, and each label code 80 corresponds to a normal status or an abnormal status. In other words, the normal status of the material 20 is configured to a label code 80, and the abnormal status of the material 20 is configured to other label codes 80. In an embodiment, each label code 80 can corresponds to more physical characteristics, e.g. the hardness value ranges in different environment conditions, and is not limited thereto.

Thus, the material status monitor 60 can compare the measured thermal variation and the first hardness value with the thermal variation ranges and the hardness value range of the label codes 80, so as to find a specific label code 80, thereby determining the status of the material 20 according to the specific label code 80.

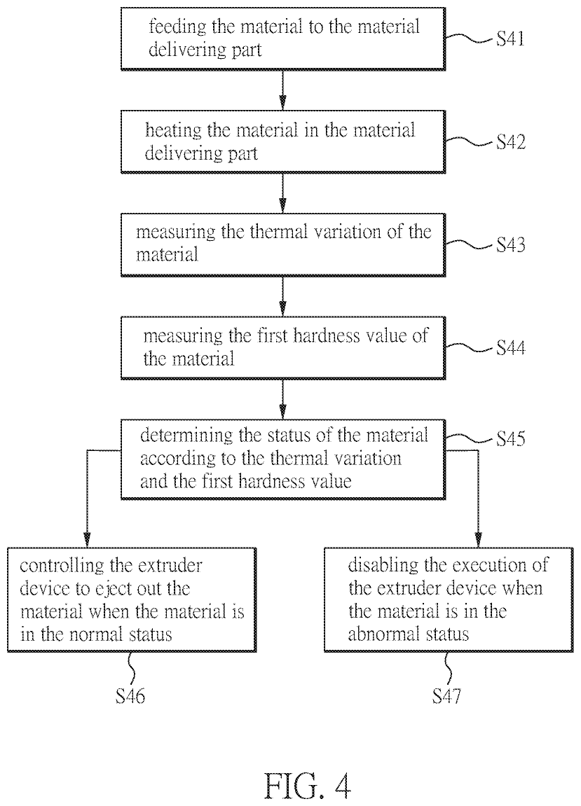

The detail of a monitoring method executed by the monitor system 1 is described herein. FIG. 4 is a flow chart of the monitoring method according to an embodiment of the invention. Please refer to FIG. 1 to FIG. 4. First, step S41 is executed in which, feeding the material 20 to the material delivering part 12. Next, step S42 is executed in which, heating the material 20 in the material delivering part 12. Next, step S43 is executed in which, measuring the thermal variation of the material 20. Next, step S44 is executed in which, measuring the first hardness value of the material 20. Next, step S45 is executed in which, determining the status of the material 20 according to the thermal variation and the first hardness value. Furthermore, step S46 is executed in which, controlling the extruder device 10 to eject out the material 20 when the material 20 is in the normal status. Furthermore, step S47 is executed, disabling the execution of the extruder device 10 when the material 20 is in the abnormal status.

In step S41, the material 20 can be installed in the material delivering part 12 by a user, or the material 20 can be feed to the material delivering part 12 by the mechanism of the 3D printer machine automatically, and is not limited thereto. In an embodiment, when the material 20 is fed to the material delivering part 12, the thermal sensor 40 can measure an original temperature of the material 20.

The step S42 can be implemented by the heater 30. In an embodiment, the microcontroller 16 can control the heater 30 to heat the material 20 according to an instruction of the first computer program product 161. In an embodiment, the heater 30 heats the material 20 with a predetermined heating temperature, wherein the predetermined heating temperature can be preset and be stored in the extruder device 10, and the predetermined heating temperature can be modified to meet a requirement.

In an embodiment, the predetermined heating temperature is set as a temperature being N degrees centigrade higher than a temperature of a softening point of the material 20, wherein N is a positive integer. In an embodiment, N is greater than or equal to 10. In an embodiment, the predetermined heating temperature is in a range from 40 to 60 degrees centigrade, and is not limited thereto. In an embodiment, the predetermined heating temperature is 50 degrees centigrade. In an embodiment, when the material 20 is heated, a part of the material 20 can be located outside the containing space 128 (e.g. only 5 mm of the material 20 is fed into the material delivering part 12), but is not limited thereto.

The step S43 can be implemented by the thermal sensor 40. In an embodiment, the microcontroller 16 can control the thermal sensor 40 to measure the thermal variation according to an instruction of the first computer program product 161.

The step S44 can be implemented by the hardness measuring module 50. In an embodiment, the microcontroller 16 can control the hardness measuring module 50 to measure the first hardness value according to an instruction of the first computer program product 161.

The step S45 can be implemented by the material status monitor 60. In an embodiment, the material status monitor 60 can find a label code 80 corresponding to the thermal variation and the first hardness value from the memory 70 for determining the status of the material 20 according to an instruction of the second computer program product 64.

The steps S46 and S47 can be implemented by the material status monitor 60 and the microcontroller 16. In an embodiment, when the material 20 is in the normal status, the material status monitor 60 can transmit a first controlling instruction to the extruder device 10 according to an instruction of the second computer program product 64, and the microcontroller 16 can control the material delivering part 12 to deliver the material 20 to the nozzle part 14 and to control the nozzle part 14 to eject out the material 20 according to the first controlling instruction. In an embodiment, when the material 20 is in the abnormal status (e.g. the material 20 is an illegal material or has error specification), the material status monitor 60 can transmit a second controlling instruction to the extruder device 10 according to an instruction of the second computer program product 64, and the microcontroller 16 disables the execution of the extruder device 10 according to the second controlling instruction, so as to avoid that the abnormal material is delivered to the nozzle part 14.

One of the features of the invention is that the status of the material 20 is determined according to a physical characteristic of the heated material 20. In an embodiment, for the purpose of improving the accuracy, the measurement of the thermal variation (e.g. the step S43) and the measurement of the first hardness value (e.g. the step S44) are executed in the specific environment, respectively.

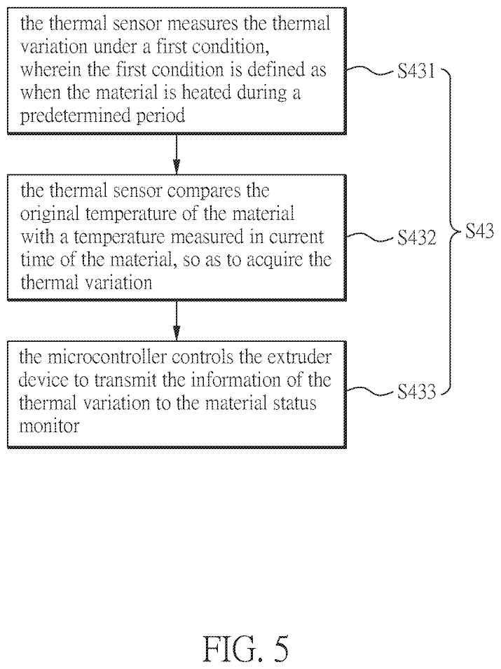

FIG. 5 is a detailed flow chart of the step S43 according to an embodiment of the invention. FIG. 5 is used to describe the detail of the measurement of the thermal variation. Please refer to FIG. 1 to FIG. 5. As shown in FIG. 5, after step S41 and step S42 are executed (e.g. after the material 20 is heated), step S431 is executed in which, the thermal sensor 40 measures the thermal variation under a first condition. The first condition is defined as when the material 20 is heated for a predetermined period of time. Next, the S432 is executed in which, the thermal sensor 40 compares the original temperature of the material 20 with a temperature measured in current time of the material 20, so as to acquire the thermal variation of the material 20. Next, step S433 is executed, the microcontroller 16 controls the extruder device 10 to transmit the information of the thermal variation to the material status monitor 60. Thus, the measurement of the thermal variation can be completed.

The purpose of steps S431 to S433 is to analyze a heat absorption capacity of the material 20, that is, the heat absorption capacity of the material 20 is used as one of the bases determining the status of the material 20.

In an embodiment, the predetermined period of time can be preset and be stored in the extruder device 10, and can be modified according to a requirement. In an embodiment, the predetermined period of time is in a range between 50 to 70 seconds, and is not limited thereto. In an embodiment, the predetermined period of time is 60 seconds.

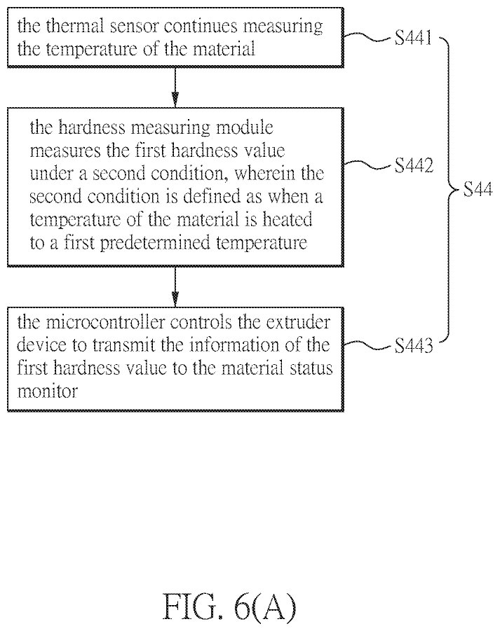

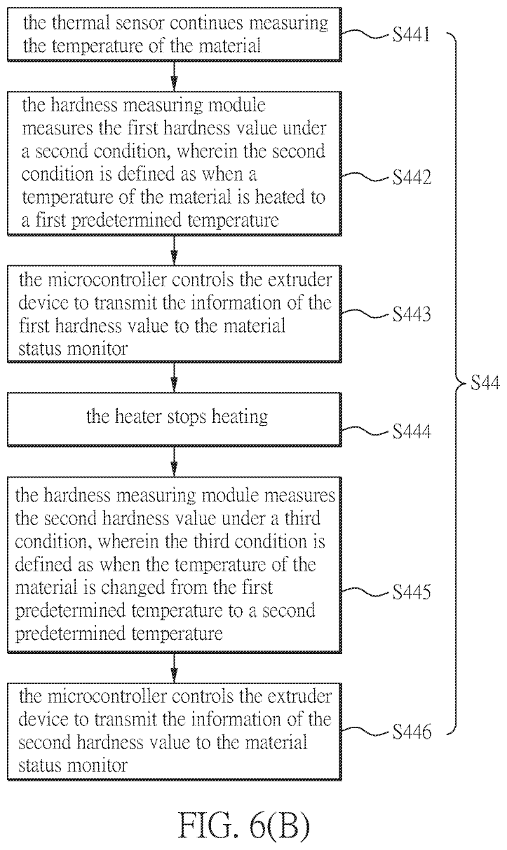

FIG. 6(A) is a detailed flow chart of step S44 according to an embodiment of the invention. FIG. 6(A) is used to describe the detail of the measurement of the first hardness. Please refer to FIG. 1 to FIG. 6(A). As shown in FIG. 6(A), after step S41 and step S42 are executed (e.g. after the material 20 is heated), step S441 is executed in which, the thermal sensor 40 continues measuring the temperature of the material 20. Next, step S442 is executed in which, the hardness measuring module 50 measures the first hardness value under a second condition, wherein the second condition is defined as when a temperature of the material 20 is heated to a first predetermined temperature. In other words, when the thermal sensor 40 measures the temperature of the material 20 is the first predetermined temperature, the hardness measuring module 50 measures a hardness value of the material 20, and sets the measured hardness value as the first hardness value. Next, step S443 is executed in which, the microcontroller 16 controls the extruder device 10 to transmit the information of the first hardness value to the material status monitor 60. Thus, the measurement of the first hardness value can be completed.

The purpose of steps S441 to S443 is to analyze a soften degree of the material 20 after the material 20 is heated, that is, the soften degree of the heated material 20 is used as one of the bases of determining the status of the material 20.

In an embodiment, the term “continues measuring the temperature of material 20” comprises a situation where the temperature is measured at intervals, and is not limited thereto.

In an embodiment, the first predetermined temperature can be preset and be stored in the extruder device 10, and can be modified according to a requirement. In an embodiment, the first predetermined temperature is configured as 30 degrees centigrade, and is not limited thereto.

Besides, in some embodiments, to improve the accuracy of the determination of the material status monitor 60, more physical characteristics of the material 20 can be used as the bases for the monitor system 1. FIG. 6(B) is a detailed flow chart of step S44 according to another embodiment of the invention. FIG. 6(B) is used to describe the detail of the measurements of the first hardness value and a second hardness value. Please refer to FIG. 1 to FIG. 6(B). As shown in FIG. 6(B), step S441 to step S443 are also executed. Because the detail of steps S441 to step S443 is described in the embodiment of FIG. 6(A), a detailed description therefor is deemed unnecessary.

After steps S441 to S443 is executed, step S444 is executed in which, the heater 30 stops heating or continues being heated during a period. Next, step S445 is executed, the hardness measuring module 50 measures the second hardness value under a third condition. The third condition is defined as when the temperature of the material 20 is changed (cooled down or heated) from the first predetermined temperature to a second predetermined temperature. In other words, when the thermal sensor 40 measures the temperature of the material 20 is the second predetermined temperature, the hardness measuring module 50 measures a hardness value of the material 20 again, and sets the measured hardness value as the second hardness value. Next, step S446 is executed in which, the microcontroller 16 controls the extruder device 10 to transmit the information of the second hardness value to the material status monitor 60. Thus, the measurement of the second hardness value can be completed.

The purpose of steps S444 to S446 is to analyze a soften degree of the material 20 in a temperature variation environment (e.g. an alternating hot and cold environment), that is, the soften degrees of the material 20 after heating or cooling are used as one of the bases of determining the status of the material 20.

In an embodiment, when the material 20 continues being heated in the step S444, the second predetermined temperature is greater than the first predetermined temperature, and is not limited thereto. In an embodiment, when the material 20 stops being heated in the step S444 (e.g. cool down), the second predetermined temperature is smaller than the first predetermined temperature, and is not limited thereto. In an embodiment, the second predetermined temperature can be preset and be stored in the extruder device 10, and can be modified according to a requirement. In an embodiment, the second predetermined temperature is 45 degrees centigrade, and is not limited thereto.

In an embodiment, when the material 20 is cooled down, the third condition is implemented by moving the material 20 to exit from and enter to a feeding opening 123(a) of the material delivering part 12 repeatedly. In other words, the rollers 124 can continue to change their rotating directions, so that at least a part of the material 20 can exit from and enter to a feeding opening 123(a) repeatedly, and thus the temperature of the material 20 can drop quickly.

In an embodiment, when the material 20 is cooled down, the third condition is implemented by providing a cooling device in the extruder device 10. In an embodiment, the cooling device can be disposed surrounding to the cover 122 or embedded into the cover 122. The cooling device cools down the cover 122 and the material 20 in the cover 122 according to an instruction from the microcontroller 16, but is not limited thereto. In an embodiment, the cooling device can be implemented by a cooler, a temperature-reduction electronic device, a temperature-reduction gas supply device (e.g., compressed gas or low temperature gas), a heat-source dispersion device (e.g., a fan), etc., and it is not limited thereto.

Besides, if the second hardness value is used as a basis for the monitor system 1, each label code 80 can further comprise a second hardness value range.

Thus, when the material status monitor 60 receives the thermal variation, the first hardness value and the second hardness value, step S45 can be executed for determining the status of the material 20.

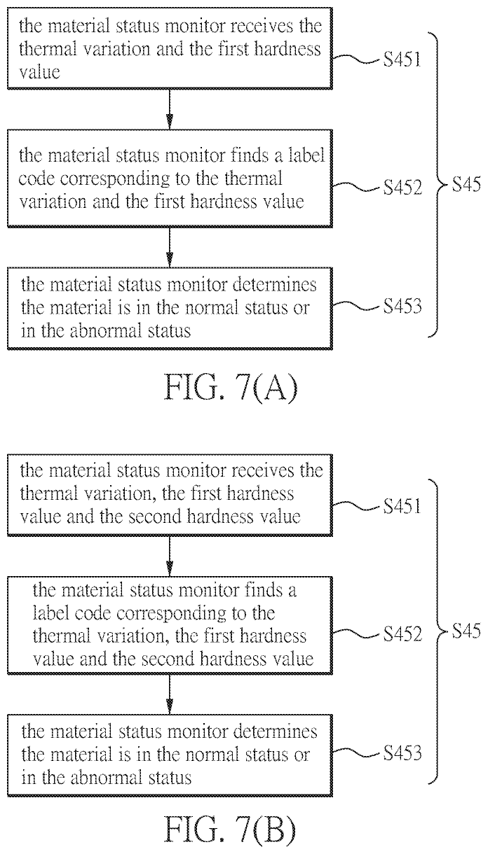

FIG. 7(A) is a detailed flow chart of step S45 according to an embodiment of the invention. FIG. 7(A) is used to describe the detail of the determination of the status of the material 20, and please refer to FIG. 1 to FIG. 6(B). First, step S451 is executed in which, the material status monitor 60 receives the thermal variation and the first hardness value. Next, step S452 is executed in which, the material status monitor 60 finds a label code 80 corresponding to the thermal variation and the first hardness value. Next, step S453 is executed in which, the material status monitor 60 determines the material 20 is in the normal status or in the abnormal status.

FIG. 7(B) is a detailed flow chart of step S45 according to an embodiment of the invention. Please refer to FIG. 1 to FIG. 7(A). First, step S451 is executed in which, the material status monitor 60 receives the thermal variation, the first hardness value and the second hardness value.

Next, step S452 is executed in which, the material status monitor 60 finds a label code 80 corresponding to the thermal variation, the first hardness value and the second hardness value. Next, step S453 is executed in which, the material status monitor 60 determines the material 20 is in the normal status or in the abnormal status according to the label code 80.

Thus, only when the material 20 is a normal material, e.g. is a legal material or has a normal quality, does the material status monitor 60 control the extruder device 10 to execute the further operations (e.g. initiate all printing system comprising the extruder device 10 or the printing task), so as to prevent the illegal material, the expired material or the material with error specification from being used. Besides, the invention can also ensure the correctness of the material 20 of a printing task. For example, when an error material is used, the monitor system 1 can detect it immediately, so as to avoid the failure of printing task.

Although the present invention has been explained in relation to its preferred embodiment, it is to be understood that many other possible modifications and variations can be made without departing from the spirit and scope of the invention as hereinafter claimed.

What is claimed is:

1. A monitor system for monitoring a status of a material in an extruder device, comprising:
a heater for heating the material in a material delivering part of the extruder device;
a thermal sensor for measuring a thermal variation of the material;
a hardness measuring module for measuring a first hardness value of the material; and
a material status monitor for determining the status of the material according to the thermal variation and the first hardness value.

2. The monitor system as claimed in claim 1, wherein the thermal sensor measures the thermal variation under a first condition, wherein the first condition is defined as when the material is heated for a predetermined period of time.

3. The monitor system as claimed in claim 1, wherein the hardness measuring module measures the first hardness value under a second condition, wherein the second condition is defined as when a temperature of the material is heated to a first predetermined temperature.

4. The monitor system as claimed in claim 3, wherein the hardness measuring module further measures a second hardness value of the material under a third condition, and the material status monitor determines the status of the material according to the thermal variation, the first hardness value and the second hardness value, wherein the third condition is defined as when the temperature of the material is changed from the first predetermined temperature to a second predetermined temperature.

5. The monitor system as claimed in claim 4, wherein the third condition is implemented by moving the material to exit from and enter to a feeding opening of the material delivering part repeatedly.

6. The monitor system as claimed in claim 1, wherein when the material status monitor determines the material is in a normal status, the material status monitor transmits a first control instruction to the extruder device, wherein the first control instruction is for controlling the extruder device to eject out the material.

7. The monitor system as claimed in claim 6, wherein when the material status monitor determines the material is in an abnormal status, the material status monitor transmits a second control instruction to the extruder device, wherein the second control instruction is for disabling an execution of the extruder device.

8. The monitor system as claimed in claim 1, further comprising a memory for storing a plurality of label codes, wherein each label code corresponds to a thermal variation range and a hardness range, each label code represents a normal status or an abnormal status, and the material status monitor finds a label code corresponding to the thermal variation and the first hardness value and determines the status of the material according to the label code.

9. The monitor system as claimed in claim 1, wherein the extruder device is suitable for a two-dimensional plane printing device, a three-dimensional space additive manufacturing device or a n-dimensional space additive manufacturing device, wherein n is a positive integer greater than 3.

10. A monitoring method executed by a monitor system for monitoring a status of a material in an extruder device, comprising the steps of:
heating the material in a material delivering part of the extruder device;
measuring a thermal variation of the material;
measuring a first hardness value of the material; and
determining the status of the material according to the thermal variation and the first hardness value.

11. The monitoring method as claimed in claim 10, wherein the thermal variation is measured in a first condition, wherein the first condition is defined as when the material is heated for a predetermined period of time.

12. The monitoring method as claimed in claim 10, wherein the first hardness value is measured in a second condition, wherein the second condition is defined as when a temperature of the material is heated to a first predetermined temperature.

13. The monitoring method as claimed in claim 10, further comprising the steps of:
measuring a second hardness value of the material under a third condition;
determining the status of the material according to the thermal variation, the first hardness value and the second hardness value;
wherein the third condition is defined as when the temperature of the material is changed from the first predetermined temperature to a second predetermined temperature.

14. The monitoring method as claimed in claim 13, wherein the third condition is implemented by moving the material to exit from and enter to a feeding opening of the material delivering part repeatedly.

15. The monitoring method as claimed in claim 10, further comprising the step of:
controlling the extruder device to eject out the material when the material is determined as in a normal status.

16. The monitoring method as claimed in claim 15, further comprising the step of:
disabling an execution of the extruder device when the material is determined as in an abnormal status.

17. The monitoring method as claimed in claim 10, further comprises the steps of:
storing a plurality of label codes, wherein each label code corresponds to a thermal variation range and a hardness range, and each label code represents a normal status or an abnormal status; and
finding a label code corresponding to the thermal variation and the first hardness value; and
determining the status of the material according to the label code.

18. The monitoring method as claimed in claim 10, wherein the extruder device is suitable for a two-dimensional plane printing device, a three-dimensional space additive manufacturing device or a n-dimensional space additive manufacturing device, wherein n is a positive integer greater than 3.

19. A computer program product stored in a non-transitory computer-readable medium for an operation of a monitor system, wherein the monitor system is used to monitor a status of a material in an extruder device, wherein the computer program product comprises:
an instruction, enabling the monitor system to heat the material in a material delivering part of the extruder device;
an instruction, enabling the monitor system to measure a thermal variation of the material;
an instruction, enabling the monitor system to measure a first hardness value of the material; and
an instruction enabling the monitor system to determine the status of the material according to the thermal variation and the first hardness value.
